(19) United States
(12) Patent Application Publication
(10) Pub. No.: US 2021/0195868 A1
(43) Pub. Date: Jul. 1, 2021

(54) Device For Tracking The Consumption Of Foodstuffs By An Animal Such As A Mammal, For Example A Cat

(71) Applicant: Specialites Pet Food, Elven (FR)

(72) Inventors: Aurélie Becques, Pluneret (FR); Emira Mehinagic, Theix (FR); Marie Le Toux, Locmaria Grand Champ (FR)

(73) Assignee: Specialites Pet Food, Elven (FR)

(21) Appl. No.: 17/047,599

(22) PCT Filed: Apr. 16, 2019
(86) PCT No.: PCT/EP2019/059814

§ 371 Date: Oct. 14, 2020

(30) Foreign Application Priority Data
Apr. 16, 2018 (FR) 1853299

(51) Int. Cl. A01K 5/02; A01K 29/00; A01K 11/00

(52) U.S. Cl. CPC A01K 5/0283; A01K 11/006; A01K 29/005

(57) ABSTRACT

The invention relates to a device for tracking the consumption of foodstuffs by an animal, comprising: a front wall, a rear wall and side walls defining therebetween a chamber, and an opening formed in the front wall in order to allow an animal to gain access to the chamber; a receptacle in the chamber, defining a cavity for storing foodstuffs; a foodstuff retrieval element for retrieving foodstuffs discharged from the cavity and not consumed by the animal, which element extends substantially from the cavity as far as one of the walls; and a weighing system which is configured to determine the weight of foodstuffs that have been taken from the cavity and not retrieved by the retrieval element over a period of time.

### FIELD OF THE INVENTION

The present invention relates to a device for tracking the consumption of foodstuffs by an animal, preferably a domestic mammal, preferably a cat or a dog, preferably a cat.

### STATE OF THE ART

There are many devices aiming at tracking the consumption of foodstuffs (food or water) by an animal. Such devices conventionally comprise a container for foodstuffs and a scale for weighing the container and its possible content. It is possible to estimate an amount of foodstuff ingested by an animal based on a difference between two weights measured by such a scale at different times.

However, most of these devices have the disadvantage of not allowing the tracking of consumption of foodstuffs by a single individual. Indeed, several individuals can simultaneously take food or water located in the container by placing themselves therearound, so that it is not possible to accurately estimate the amount of foodstuff ingested by each of these individuals.

To solve this problem, devices have been proposed comprising a casing defining a chamber in which the container and the scale are arranged. The casing allows restricting the access to the chamber, thus favoring a withdrawal of foodstuff from the container by one animal at a time.

However, devices including such casings have the following drawback: an animal having entered the chamber and taking food or water from the container arranged in the chamber can splash pieces of food or drops of water in the chamber outside the container by untimely movements, so that these pieces or drops are neither weighed by the scale nor ingested by the animal. This results in a bias in the estimation of the amount of foodstuffs ingested by the animal.

Such splashes are particularly likely to occur in the case where the container contains water. Indeed, some animals such as the cat have a natural reflex to paw in stagnant water, causing such splashes.

Document WO 2017/214698 also discloses a device for tracking the consumption of foodstuffs defining a chamber in which a container is placed. The container is rotatably mounted relative to the rear wall of the chamber. An animal can take foodstuffs from this container. This device also comprises a weighing system located outside the chamber to which the animal has access. This weighing system is configured to weigh, before a meal of the animal, an amount of foodstuffs which will then be transferred to the container. This system is also configured to weigh, after the meal of the animal, the leftovers not consumed by the animal. To carry out this second weighing, the container is turned by 180 degrees, thereby making it pass behind the rear wall 132 of the chamber. The container therefore leaves the chamber and enters another chamber in which the weighing system is located. However, the device of document WO 2017/214698 has the disadvantage of not allowing the implementation of weighing during the meal of the animal. With such a device, it is therefore not possible to follow accurately the kinetics of consumption of the animal during a meal.

### DISCLOSURE OF THE INVENTION

An aim pursued by the present invention is to estimate more accurately an individual amount of foodstuffs consumed by an animal such as a mammal.

This aim is achieved by a device for tracking the consumption of foodstuffs by an animal such as a mammal, for example a cat, the device comprising:
a front wall, a rear wall and two side walls defining therebetween a chamber, and a window formed in the front wall to allow an animal to access the chamber from outside the tracking device,
a container arranged in the chamber between the walls, the container defining a cavity to store foodstuffs intended to be taken by the animal,
a foodstuff retrieval element arranged in the chamber between the cavity of the container and one of the walls to retrieve foodstuffs expelled out of the cavity and not consumed by the animal, in which the foodstuff retrieval element extends substantially from the cavity of the container up to one of the walls,
a weighing system configured to determine a weight of foodstuffs that have been taken from the cavity and that have not been retrieved by the retrieval element of the tracking device during a period of time, the weighing system comprising a scale arranged in the chamber and configured to acquire measurements indicative of the cumulative weight of the container defining the cavity and of foodstuffs contained in the cavity.

In the present text, the term “food” is considered to cover both solid food and liquid food (in particular water or any other drink).

Furthermore, in the present text, it is considered that a retrieval element extends from the cavity of the container “up to” a reference wall when the maximum distance between the retrieval element and the reference wall is less than 5% of the total distance separating the reference wall from the wall opposite to the reference wall relative to the chamber. In the case where the reference wall is one of the side walls, the wall opposite thereto is the other side wall; in the case where the reference wall is the front wall, the wall opposite thereto is the rear wall.

The or each retrieval element has the effect of being able to retrieve foodstuffs taken by an animal in the container but falling from its mouth towards one of the walls, said retrieved foodstuffs being weighed by the weighing system. However the walls have the effect of restricting the access to the container and to its content, and therefore promoting a withdrawal of foodstuff from the container by one animal at a time, but also have the effect of constituting natural barriers retaining the foodstuff splashes out of the container by the animal having accessed the chamber. Thus, even foodstuffs splashed forcefully on the side walls can rebound and be retrieved by a retrieval element, which could not happen if the device were devoid of such walls.

Thus, any foodstuff that has not been ingested by the animal having accessed the chamber either falls back into the container where it was originally stored, or is retrieved by a retrieval element, and is thus necessarily counted in the weight weighed by the weighing system. A weight of foodstuffs that have not been ingested by the animal having accessed the chamber is therefore estimated more accurately by the device. This is why an amount of foodstuffs consumed by the animal, which directly depends on the weight determined by the weighing system, can be estimated more accurately by the device.

In addition, the fact that the scale is arranged in the chamber where the container is located, and where the animal can have access allows weighing the container and its content while the animal takes foodstuffs from the cavity of the container. The weight data acquired by the scale thus allow accurately tracking the kinetics of consumption of the animal during its meal.

The device according to the invention may also comprise the following optional characteristics, taken alone or in combination when technically possible.

The ratio between, on the one hand, the maximum distance between the retrieval element and the reference wall and, on the other hand, the total distance separating the reference wall from the wall opposite to the reference wall relative to the chamber, is preferably less than 4%, even less than 3.5%, even less than 3%, even less than 2.5%, even less than 2%, even less than 1.5%, even less than 1%, even less than 0.5%, even less than 0.25%, even less than 0.1%.

The wall up to which the retrieval element extends can be a first of the side walls.

The device may comprise a second foodstuff retrieval element extending from the cavity of the container up to a second of the walls, in which the container is arranged between the first wall and the second wall.

The container may have two opposite edges, and the container may have a width measured between its two opposite edges which is substantially equal to a distance separating the first and second walls, so that the container extends substantially from the first wall up to the second wall. In this case, the first and the second retrieval element can form two upper rims of the container each extending from the cavity up to one of the edges. This embodiment has the advantage of being simple to implement and of requiring only one scale.

The device may comprise flexible seals connecting respectively the opposite edges of the container to the first and second walls.

The device may comprise a first foodstuff retrieval element comprising a second container that can be weighed independently of the container defining the cavity, in which case the weighing system further comprises: a second scale configured to acquire measurements indicative of the weight of the second container and of foodstuffs retrieved by the second container, and a processing unit configured to determine the weight of the foodstuffs that have been taken from the container and that have not been retrieved by any retrieval element during the period of time, from the measurements acquired by the first scale and the measurements acquired by the second scale. This embodiment has the advantage of being able to accurately determine the amount of foodstuffs that have been splashed out of the container defining the cavity, which may constitute information of interest.

The container defining the cavity may comprise a first upper rim extending from the cavity towards one of the walls so as to overhang the second container.

The device may comprise a second foodstuff retrieval element comprising a third container that can be weighed independently of the container defining the cavity and of the second container, in which case the weighing system comprises a third scale configured to acquire at least one measurement indicative of the weight of the third container and of foodstuffs retrieved by the third container, and the processing unit is configured to calculate the weight of the foodstuffs that have been taken from the container and that have not been retrieved by any retrieval element during the period of time, from the measurements acquired by the first, second and third scales.

The container defining the cavity may comprise a second upper rim extending from the cavity towards another of the walls so as to overhang the third container, the cavity being arranged between the first and second upper rims.

The weighing system may comprise a scale and an infinite impulse response filter configured to eliminate or not a measurement acquired by the scale depending on a weight measurement previously acquired by the same scale.

The weighing system may comprise an electronic scale, less accurate than a scale having an accuracy of 0.01 grams, the electronic scale having for example an accuracy of 0.1 grams.

The window may have a diameter less than or equal to 19 centimeters, preferably less than or equal to 14 centimeters.

In the present text, it is considered the diameter of an object is the greatest length that separates two points of the object. Thus, the diameter of the window is the greatest length that separates two points of the edge which surrounds and delimits this window. For example, if the window has a rectangular shape, its diameter is its largest diagonal.

The window may have a lower edge elevated relative to the container.

The device may comprise a rim extending between the window and the container so as to partially overhang the container, in which the rim is preferably inclined towards the container so that a foodstuff falling on the rim then falls back into the container.

The device may comprise means for adjusting the dimensions of the window.

The window can be arranged to be at least 7 centimeters from a floor on which the device is laid, preferably at least 9 centimeters from the floor.

The device may comprise a roof having a convex and/or inclined shape to prevent an animal from standing on the roof when the device is laid on a floor.

The front wall may be at least partly transparent.

The device may comprise detection means configured to detect the entry and the exit of an animal into/from the chamber via the window, in which case the weighing system is configured so that the period of time begins when the detection means detect the entry of the animal into the chamber and ends when the detection means detect an exit of the animal out of the chamber.

The detection means may comprise an infrared beam emitter, and a receiver arranged to receive the infrared beam emitted by the emitter, the emitter being arranged so that the beam is interrupted by an animal accessing the chamber via the window.

The device may comprise a radio-identification reader adapted to receive a radio-label carried by an animal accessing the chamber via the window of the data allowing this animal to be identified in a database of individuals.

### DESCRIPTION OF THE FIGURES

Other characteristics, aims and advantages of the invention will emerge from the following description, which is purely illustrative and not limiting, and which should be read with reference to the appended drawings in which:

FIG. 1 is a side view of a container for foodstuffs according to an embodiment of the invention.

FIG. 2 is a top view of the container represented in FIG. 1.

FIG. 3 is a perspective view of a device for tracking consumption of foodstuffs by an animal, according to a first embodiment of the invention.

FIG. 4 is a top view of the tracking device according to the first embodiment.

FIG. 5 is a top view of the tracking device according to the first embodiment inside which the container of FIG. 1 is arranged.

FIG. 6 is a side view of the tracking device according to the first embodiment, in a closed configuration.

FIG. 7 is a side view of the tracking device according to the first embodiment, in an open configuration.

FIG. 8 is a sectional view of the tracking device according to the first embodiment.

FIG. 9 represents schematically some elements of the tracking device according to the first embodiment.

FIG. 10 is a sectional view of a tracking device according to a second embodiment. In all of the figures, similar elements bear identical references.

### DETAILED DESCRIPTION OF EMBODIMENTS

### 1) First Embodiment of a Tracking Device

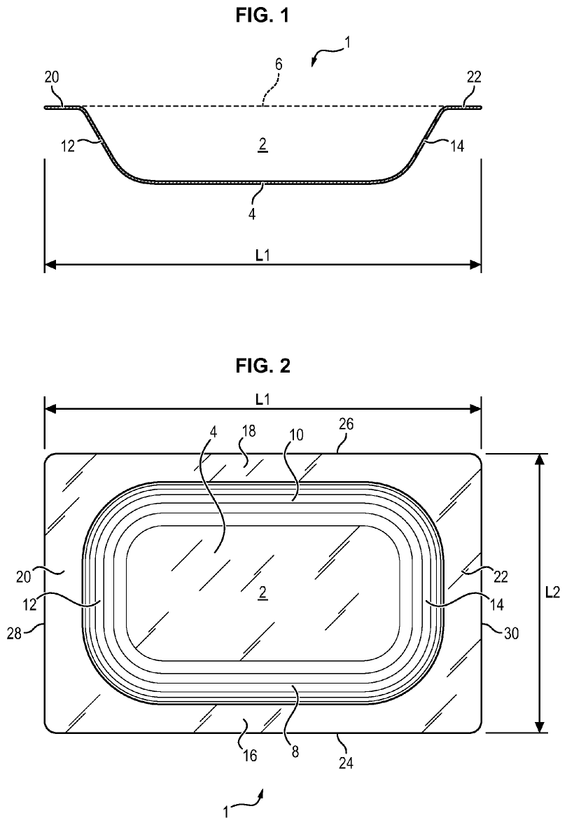

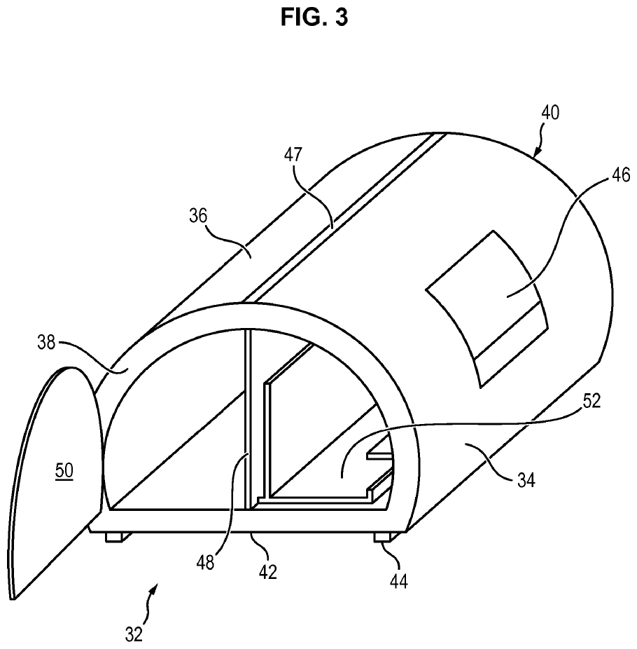

Referring to FIGS. 1 and 2, a container 1 for foodstuffs according to a first embodiment defines a cavity 2 for receiving foodstuffs.

The container 1 is in the form of a bowl comprising a bottom wall 4 and an upper opening 6 making it possible to access the cavity 2, the cavity 2 extending between this upper opening 6 and the bottom wall 4.

The container 1 also comprises a front wall 8, a rear wall 10, and two side walls 12, 14 defining therebetween the cavity 2 and the upper opening 6.

The container 1 has for example a substantially rectangular bottom wall 4 and a substantially rectangular upper opening 6. The upper opening 6 may have larger dimensions than those of the bottom wall, as can be seen in FIGS. 1 and 2; in this case, the front 8, rear 10 and side 12, 14 walls of the container 1 can be flared. In the embodiment represented in FIGS. 1 and 2, the upper opening 6 and the bottom wall 4 have rectangular shapes with rounded corners.

The container 1 also comprises four upper rims 16, 18, 20, 22: a front rim 16, a rear rim 18, and two side rims 20, 22.

The upper opening 6 of the container 1 is arranged between the two side upper rims 20 and 22, and between the front and rear upper rims 16 and 18.

The container 1 has four free edges 24, 26, 28, 30: a front edge 24, a rear edge 26 opposite to the front edge 24 relative to the cavity 2, and two side edges 28, 30 mutually opposite relative to the cavity 2.

Conventionally, L1 is the distance that separates the two free side edges 28, 30, and the length L2 of the container is the distance that separates the front and rear free edges 24, 26.

Each rim 16, 18, 20, 22 is substantially parallel to the bottom wall 4. As a variant, at least one of these rims 16, 18, 20, 22 is inclined towards the cavity 2, so that a foodstuff fallen on such a rim naturally falls back into the cavity 2.

Each upper rim 16, 18, 20, 22 extends from the cavity 2 (more accurately from the upper opening 6 leading to this cavity 2) up to the corresponding free edge 24, 26, 28, 30.

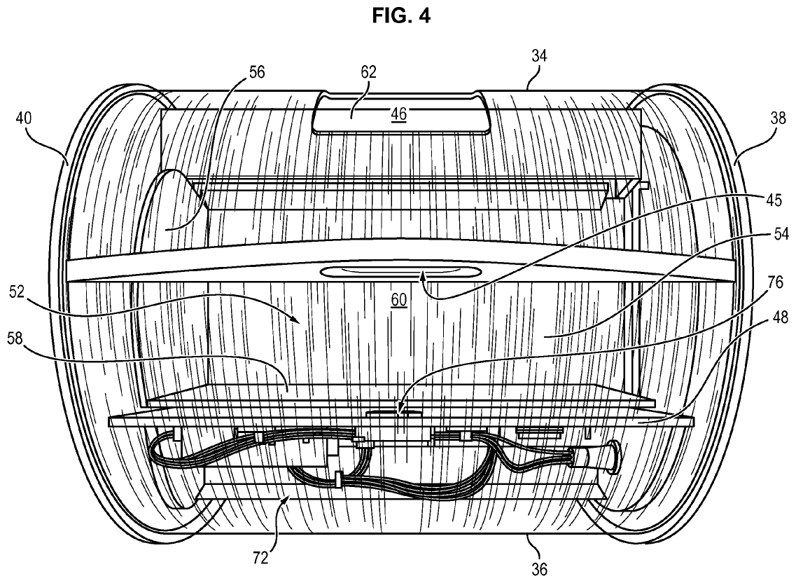

With reference to FIGS. 4 to 7, a device for tracking the consumption of foodstuffs by an animal such as a cat according to a first embodiment comprises a casing 32.

The casing 32 comprises the following four walls leading to the exterior of the device: a front wall 34, a rear wall 36 and two side walls 38, 40.

The front wall 34 connects one of the side walls 38 to the other side wall 40. Likewise, the rear wall 36 connects one of the side walls 38 to the other side wall 40.

The casing 32 also comprises a base 42. Each of the front, rear and side walls 34, 36, 38, 40 is connected to the base 42. The base 42 is planar.

The base 42 has a lower surface intended to be facing a support on which the casing 32 is laid (floor, furniture, etc.), and an upper surface opposite to the lower surface.

The tracking device comprises four feet 44 fixed to the lower surface of the base 40. These feet 44 are made of a material capable of adhering to a smooth floor, so as to prevent the casing 32 from sliding along this floor, for example an elastic material, in particular made of rubber. The feet can be replaced by other means for stabilizing the device.

The side walls 38, 40 are planar and parallel to each other.

The front wall 34 is bent: from the base 42 towards the top of the casing 32, the front wall 34 is curved towards the interior of the casing 32.

A window 46 is formed in the front wall 34. This window 46 allows an animal located outside the casing 32 to access the interior of the casing 32. The window has for example a rectangular shape.

The rear wall 36 is also bent: from the base 42 towards the top of the casing 32, the rear wall is curved towards the interior of the casing 32.

The front wall and the rear wall 34, 36 meet at the top of the casing 32 so as to define a roof 47 opposite to the base 42 relative to the casing 32.

The roof 47 is convex and/or inclined relative to a floor on which the feet 44 of the casing 32 rest. In this way, an animal cannot stand on the roof without slipping. Thus, an animal wishing to pass its head through the window 46 to access the interior of the casing 32 is not prevented from doing so because of another animal which would stand on the roof.

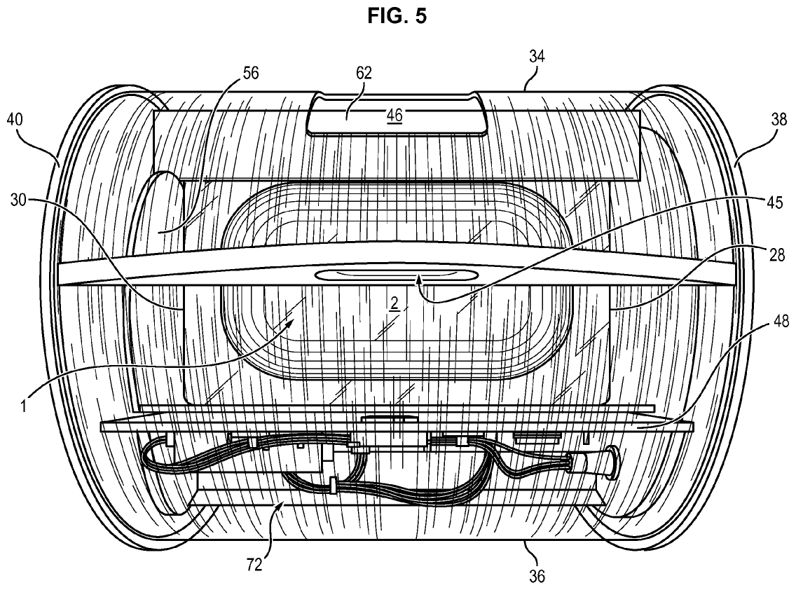

The casing 32 comprises a handle 45 graspable by a user, so as to make the device transportable. Preferably, the handle is formed on the roof 47, as represented in FIGS. 4 and 5. Such a handle 45 is in particular advantageous in the case of tests carried out in different places.

Advantageously, the window 46 is adjusted so as to let pass only the head of an animal.

Preferably, the window 46 has a lower edge elevated relative to the container 1 when the latter is laid in the casing 32.

Means for adjusting the dimensions of the window 46 (not represented) can be provided in the tracking device. These adjustment means may for example comprise a panel sliding along the front wall 34. These adjustment means have the advantage of allowing to adapt the tracking device to animals having heads of different sizes.

The lower edge of the window 46 is preferably arranged to be at least 7 centimeters from a floor on which the device is laid, preferably at least 9 centimeters from the floor. Such an elevation allows the front wall to form an obstacle between the animal and the interior of the casing 32. In this way, this elevation makes a complete entry of an animal inside the casing it more difficult. The risks of a long installation of the animal in the casing are therefore reduced thanks to this elevation.

It should be noted that the device does not comprise a corridor formed between two parallel walls and on which the animal should walk to access the interior of the casing 32. Such a corridor could oppress the animal. Such a corridor could also be occupied by such an animal, thus blocking the access to the interior of the casing for other animals. Such blockage is undesirable because it disrupts the usual behavior of these animals.

If the animal is a cat, and in particular an adult cat, each side edge of the window 46 is preferably separated from each side wall 38, 40 of the casing by a distance greater than or equal to 9 centimeters.

The window 46 has a diameter less than or equal to 19 centimeters, preferably less than or equal to 14 centimeters.

These dimensions are advantageous because they are adapted to allow only one adult cat to pass its head through the window. Thus, it is certain that two adult cats cannot simultaneously access the interior of the casing 32 and at the same time take therefrom food located therein, which allows, as will be seen below, accurately estimating an individual consumption of a cat among a cohort of several cats.

These advantageous dimensions, combined with the fact that the window is elevated, have the effect of preventing even more effectively an undesirable installation of a cat inside the casing 32.

For example, the distance that separates the lower edge and the upper edge of the window can be of 10 centimeters, and the distance that separates the two side edges of the window is of 9 centimeters.

At least one of the walls 34, 36, 38, 40 of the casing 32 is at least partly transparent. This allows an animal located outside the device to see what is in the casing 32, and an animal having passed its head through the window to see what is happening outside the casing 32, and therefore avoids stressing them. If the animal was stressed, this could affect its behavior and particularly its consumption of foodstuffs placed inside the casing 32. Thus, the individual consumption sought to track over time by means of this tracking device could be biased by such stress.

Preferably, the front wall 34 is at least partly transparent, for example totally transparent. This is advantageous because it greatly reduces the stress of some animals such as the cat. Indeed, a cat would be particularly stressed to be unable to verify what is happening around it while it passed its head through the window 46.

The casing 32 further comprises a partition 48 from the interior of the casing 32 into two compartments: a first compartment and a second compartment.

The partition 48 extends parallel to the front and rear walls 34, 36 of the casing 32. The partition joins the side walls 38 and 40.

The first compartment is arranged between the partition 48 and the rear wall 36. The second compartment is arranged between the partition 48 and the front wall 34. As the window 46 is formed in the front wall 32, this window 46 gives access to the second compartment.

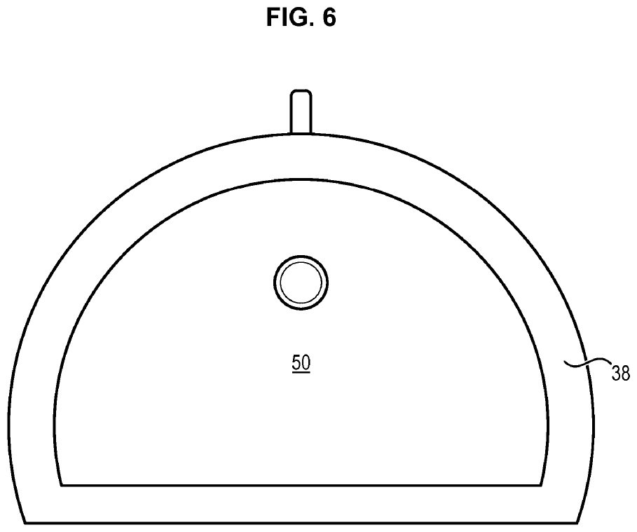

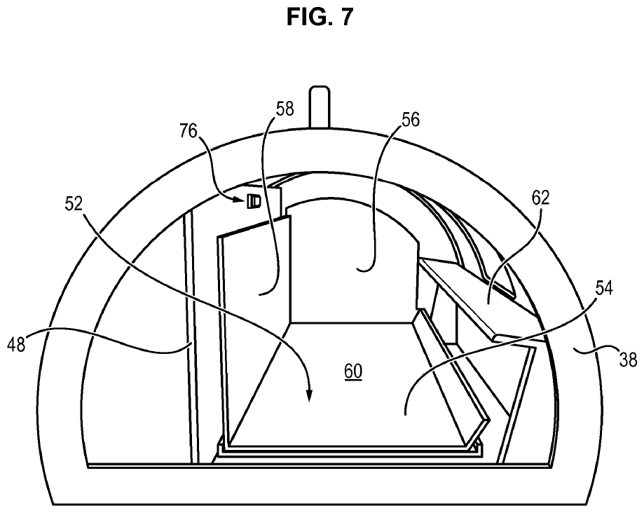

The casing 32 comprises a door 50 formed in the side wall 38, capable of being opened to allow a person outside the tracking device to access the second compartment (as represented in FIG. 7), or even the first compartment, and of being closed to prevent an animal from entering the casing 32 through the door 50 (as represented in FIG. 6). The dimensions of the door 50 are adapted to allow entering the container 1 in the second compartment or extracting it therefrom. This has the advantage of being able to clean the container 1 outside the device, which is easier than to perform such cleaning while the container 1 is in the casing 32, for example in the second compartment.

The tracking device comprises a support 52 for the container 1. The support 52 is arranged in the casing 32, for example in the second compartment. This support 52 is preferably removable relative to the rest of the device, so that it can be advantageously extracted from the casing 32.

The support 52 comprises a bottom wall 54 extending parallel to the base 42 of the casing 32. The container 1 is intended to rest on the bottom wall 54 of the support 52.

The support 52 further advantageously comprises at least one wall forming a screen between the container laid on the support and the casing 32. This allows further facilitating the cleaning, the walls that can be soiled being those of the removable support 52 and not those of the casing 32.

More specifically, the support 52 can comprise a first wall 56 forming a screen between the container 1 laid on the support 52 and the side wall 38 of the casing 32, and a second wall 58 forming a screen between the container 1 laid on the support 32 and the partition 48. The first wall 56 and the second wall 58 are connected to the bottom wall 54 and extend perpendicular thereto, therefore vertically. The first wall 56 and the second wall 58 are connected together so as to form an L shape (as represented in FIG. 7).

Generally, the tracking device comprises a front wall, a rear wall and two side walls defining therebetween a chamber 60 in which the container 1 is arranged. In other words, the container 1 is located between the four walls that define the chamber 60.

In the first embodiment of a tracking device, when a support 52 is present, the four walls that define the chamber 60 are the following: the side wall 38 of the casing 32, the front wall 34 of the casing 32, the first wall 56 of the support 52 and the second wall 58 of the support 52. The bottom wall 54 of the support 52 also defines a bottom of this chamber 60. In this embodiment, the chamber 60 where the container 1 is received is included in the second compartment.

The window 46 formed in the front wall 34 of the casing 32 allows an animal to access the chamber 60 and to take foodstuffs located in the cavity 2 of the container 1, when the container is itself in the chamber 60.

The casing 32 also comprises a rim 62 extending between the window 46 and the container 1 so as to overhang the container 1, when the container is arranged in the chamber.

The rim 62 is preferably inclined towards the container 1 so that a foodstuff falling on the rim then falls back into the container. The angle of inclination of the rim 62 is for example comprised between 15 degrees and 45 degrees relative to the base 42. The rim 62 is located under the window 46.

Furthermore, the tracking device comprises at least one foodstuff retrieval element, the retrieval element being arranged in the chamber 60 between the cavity 2 of the container 1 received in the chamber 60 and one of the walls 34, 38, 56, 58 that define therebetween the chamber 60.

In the first embodiment represented in FIGS. 3 to 9, the retrieval elements are four in number. The foodstuff retrieval elements are formed by the four upper rims 12, 14, 16, 18 of the container 1 itself.

At least one of these retrieval elements (therefore at least one of these upper rims 12, 14, 16, 18) extends substantially from the cavity 2 of the container up to one of the walls 34, 38, 56, 58 defining the chamber 60. This allows this retrieval element to retrieve more foodstuffs leaked from the cavity 2 of the container 1.

As indicated above, it is considered that a retrieval element extends from the cavity of the container “up to” a reference wall defining the chamber 60 where the container 1 is received, when the maximum distance between the retrieval element and the reference wall is less than 5% of the total distance separating the reference wall from the wall opposite thereto relative to the chamber 60. In the case where the reference wall is the side wall 38 of the casing, the wall opposite thereto relative to the chamber 60 is the first wall 56 of the support 52; in the case where the reference wall is the front wall 38 of the casing 32, the wall which is opposite thereto relative to the chamber 60 is the second wall 58 of the support 52.

In the embodiment represented in FIGS. 4 to 7, the upper rims 18, 20 and 22 extend respectively up to the walls 58, 34 and 56 defining the chamber where the container 1 is located.

On the other hand, in the presence of the rim 62, the upper front rim 16 of the container is at a distance from the front wall 34 of the casing 32. This distance is greater than or equal to 5 centimeters. Such an arrangement is more comfortable for the animal having passed its head through the window 46. Indeed, if the container 1 was too close to the front wall 34, the animal should lower its head at a relatively large angle, this which is uncomfortable.

The width L1 of the container 1 measured between its two opposite side edges 28, 30 is substantially equal to the distance separating the side wall 38 of the casing and the wall 56 of the support 52, so that the container 1 extends substantially from the side wall 38 up to the first wall 56.

On the other hand, in the presence of the rim 62, the length L2 of the container 1 measured between its two front and rear opposite free edges 24, 26 is less than the distance separating the front wall of the casing 34 and the second wall 58 of the support 52.

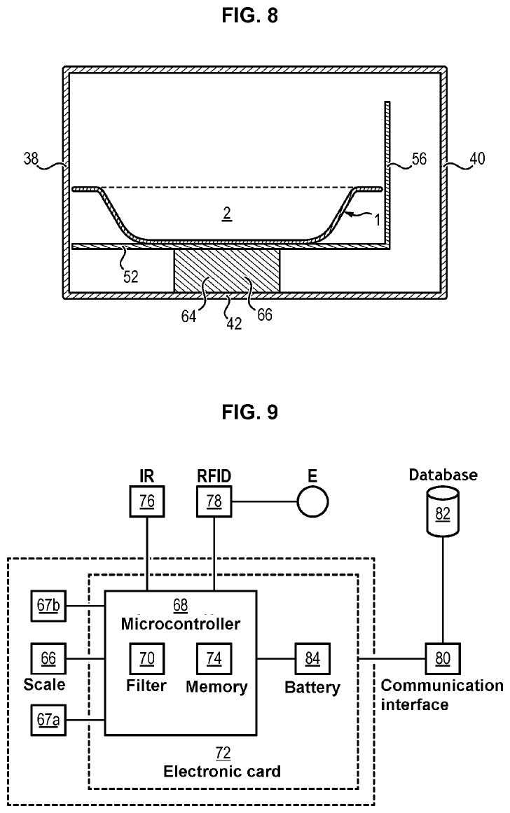

With reference to FIG. 8, the tracking device also comprises a weighing system 64. In general, the weighing system 64 is configured to determine a weight of foodstuffs that have been taken from the container 1 (when this container 1 rests in the chamber 60 to be weighed therein) and furthermore that have not been retrieved by any retrieval element of the tracking device during a given period of time.

In other words, the weighing system 64 is configured to determine a weight of foodstuffs corresponding to the difference between: the weight of foodstuffs that have been taken from the container 1 in a given period of time, and a weight of foodstuffs that have been retrieved by all of the retrieval elements in the given period of time. This weight of foodstuffs corresponds to the weight of foodstuffs consumed during the given period of time.

The weighing system typically includes a scale 66.

The scale 66 is arranged in the second compartment. The scale 66 rests on the upper surface of the base 42. The scale 66 is for example fixed to the upper surface of the base 42.

The support 52 is laid on the scale 66, so that the scale can weigh simultaneously: the support 52, the container 1 laid on the support 52 in the chamber 60, as well as foodstuffs located not only in the cavity 2 of the container 1 but also on each upper rim of the container 1 ensuring a foodstuff retrieval function.

The scale 66 is preferably an electronic scale.

The scale 66 is preferably less accurate than a scale having an accuracy of 0.01 grams. The inventors have found that an accuracy of more than 0.01 grams was so high that it would be likely to create variations of unwanted weights in a series of weight measurements acquired by the scale. Such variations are for example caused by the environment, such as by an animal walking in the vicinity of the device. Using a less accurate scale 66 allows avoiding the unwanted weight variations mentioned above. The scale 66 has preferably an accuracy of 0.1 grams.

Furthermore, the scale 66 is preferably more accurate than a scale having an accuracy of 0.2 grams. This allows accurately tracking the liquid consumption of an animal when the foodstuff in the container is a liquid.

The scale 66 is for example configured to acquire a series of weight measurements, for example periodically.

With reference to FIG. 9, the weighing system 64 comprises an infinite impulse response filter 70 which is configured to eliminate or not a measurement acquired by the scale 66 as a function of the value of a weight measurement previously acquired by the same scale 66. An advantage provided by this impulse response filter is to smooth unwanted weight variations in a series of measurements acquired by the scale 66. Such unwanted weight variations are typically caused when the animal moves container 1, for example by pressing it with its paw. With a view to tracking foodstuff consumption in an animal, the weight of the container 1 and its content can only decrease over time (each time an animal takes foodstuffs from the container). This infinite impulse response filter 70 is advantageous because it allows avoiding listing weight increases over time.

The infinite impulse response filter is configured to eliminate a measurement of value B acquired by the scale 66 only if the value B is greater than the value of a previous measurement of value A added by a certain predetermined value X (in other words, if B>A+X). The value X is a residual predetermined value representative of a noise as a function of the accuracy of the scale 66. As a variant or as a complement, the infinite impulse response filter is configured to eliminate the measurement of value B in the case where B<A+Y, where Y is predetermined.

The infinite impulse response filter 70 is for example a component external to the scale 66. It is included in an electronic card 72 arranged in the first compartment, so as to be isolated from the foodstuffs located in the second compartment.

The tracking device also preferably comprises a memory 74 for storing measurements acquired by the scale 66 and/or data produced by the infinite impulse response filter 70. This memory 74 is typically included in the electronic card 72.

The tracking device also comprises preferably detection means 76 configured to detect the entry and the exit of an animal into/from the chamber, via the access window 46.

For example, the detection means 76 comprise an infrared beam emitter, and a receiver arranged to receive the infrared beam emitted by the emitter, the emitter being arranged so that the beam is interrupted by an animal accessing the chamber via the window 46.

The tracking device also comprises a radio-identification reader 78 adapted to receive from a radio-label E carried by an animal accessing the chamber 60 via the window 46, data making it possible to identify this animal in the database 82.

The detection means 76 are adapted to transmit signals to the weighing system 64, these signals being indicative of an entry and of an exit of an animal into/out of the chamber 60.

The emitter and the receiver are arranged in the casing 32.

The emitter and the receiver are for example arranged on the partition 48 facing the window 46, so that the infrared beam emitted by the emitter passes through the window 46 and therefore exits outside the casing 32. When an animal access the chamber, this beam is reflected by the body of the animal (typically its head) and then captured by the receiver, which is located in the vicinity of the emitter. It should be noted that, in this case, the ray emitted by the emitter can also be reflected by an animal which is located outside the casing 32, which could lead to false alarms or missed detections. Thus, when the emitter and the receiver are arranged at this location of the partition 48, the reader 78 is part of the detection means 76. An entry signal is emitted in the case where the following two conditions are met: i) the ray emitted by the emitter is captured by the receiver, and ii) a radio-label E carried by an animal falls within the range of the reader 76.

As a variant, the emitter is arranged so that the beam it emits propagates in a direction parallel to the front wall 34. For example, the emitter and the receiver are arranged on either side of the window. When the receiver no longer receives the beam, it means that the body of the animal having passed its head through the window has interrupted the beam.

The tracking device also comprises preferably a communication interface 80 for communicating via network with a remote server hosting a database 82 of individuals. The communication interface is of the wireless (Wi-Fi, Bluetooth, etc.) or wired type. Preferably, the communication interface uses the ZigBee protocol, which in particular has the advantages of being easily configurable.

The communication interface 80 comprises for example an antenna or an Ethernet port coupled to a network component integrated into the electronic card 72.

The device further comprises a battery 84 for supplying energy to all the electronic components of the device (in particular the weighing system 64, the detection means 76 and the radio-identification reader 78). The battery 84 is arranged in the first compartment.

The tracking device according to the first embodiment operates in the following manner.

Foodstuffs are placed in the cavity 2 of the container 1. The container 1 is placed in the chamber 60 by the door 50. The door 50 is then closed again.

An animal wishing to have a feeding sequence passes its head through the window 46 until it overhangs the container 1.

As indicated above, the elevation of the window 46, the particular dimensions of the window 46, and the adjustable nature of the window 46 are all characteristics which contribute to preventing the animal from fully entering the chamber 60, and particularly preventing this animal from being itself weighed by the weighing system 64.

The detection means 76 detect the entry of the animal's head into the chamber 60 via the window 46 (typically by detection, by the receiver, of an interruption of the infrared beam emitted by the emitter). The detection means 76 transmit to the weighing system 64 a signal indicative of such an entry. Preferably, the entry signal is transmitted to the electronic card 72.

An initial measurement P acquired by the scale 66 is selected from the receipt of this entry signal. The initial measurement P is stored in memory 74. This initial measurement P is representative of the cumulative weight of the support 52, of the container 1 and of its content before consumption.

Furthermore, the animal wears a radio-label E which enters into communication with the radio-identification reader 78 when the latter accesses the chamber 60. The radio-identification reader 78 receives from the radio-label E carried by the animal an identifier specific to this individual. This individual identifier is stored in memory 74 in association with the initial measurement P.

Once entered into the chamber 60, the animal can take foodstuffs from the cavity 2 of the container 1. The scale 66 therefore continues to acquire new measurements, which allows having an accurate tracking of the consumption kinetics of the animal. Typically, the scale 66 acquires measurements periodically.

Some foodstuffs taken are ingested by the animal. Other sampled foodstuffs can fall back into the cavity 2 of the container 1. Still other sampled foodstuffs can be splashed by the animal making an untimely movement of the head in the direction of one of the walls defining the chamber 60, then falling on one of the upper rims 12, 14, 16, 18 of the container 1 (in other words, be retrieved by one of the retrieval elements of the device).

Once the feeding sequence is finished, the animal exits the chamber 60 by withdrawing its head through the window 46 out of the casing 32.

At this instant, the detection means 76 detect the exit of the animal's head out the chamber 60 via the window 46 (typically by detection, by the receiver, of an infrared beam emitted by the emitter and which was hitherto interrupted by the body of the animal, typically by its head or its neck). The detection means 76 transmit to the weighing system 64 a signal indicative of such an exit.

A final measurement Q acquired by the scale 66, then selected by the electronic card 72 immediately before the receipt of this exit signal, is stored in the memory 74. This final measurement Q is representative of the cumulative weight of the support 52, of the container 1 and of their content.

The weighing system 64 calculates the difference ΔP=Q−P. This weight difference ΔP is representative of a weight of foodstuffs that have been taken from the container 1 but that have not been retrieved by any of the retrieval elements 12, 14, 16, 18 of the tracking device, i.e. a weight of foodstuffs actually consumed by the animal during the feeding sequence.

This weight difference ΔP is then stored in the memory 74 in association with the identifier of the individual from the radio-label E. This association allows knowing which individual has taken a weight of foodstuffs from the container 1.

Said calculated difference in weight ΔP and the associated identifier can be communicated, by means of the communication interface 80, to the remote server and stored in the database 82 of this server.

The tracking device can advantageously be used to determine the palatability of a foodstuff product, for example in the context of a monadic test or in the context of a versus test.

Particularly, two copies of the device can be used in the context of a versus test. The two copies contain two different foodstuff products (typically, a control product and a product to be tested, respectively). By comparing the data acquired by the two copies of the device, a level of palatability for the tested product can be deduced.

### 2) Second Embodiment of a Tracking Device

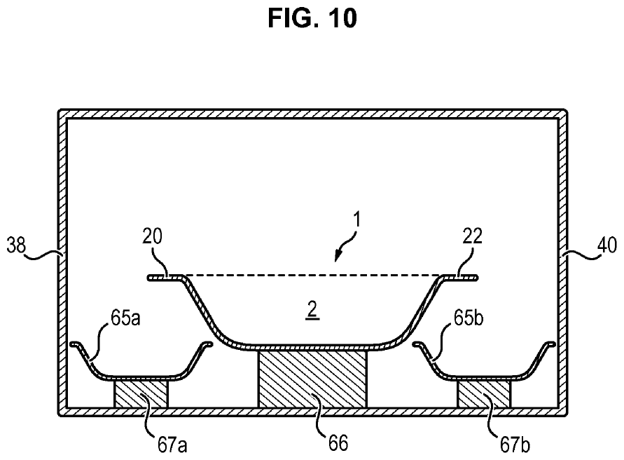

FIG. 10 represents a second embodiment of a tracking device, which differs from the tracking device according to the first embodiment by the following characteristics.

No support 52 is present in this device according to the second embodiment. In this case, the container 1 is directly laid on the scale 66. The scale 66 then weighs only the container 1 and its possible content.

The walls that define the chamber where the container 1 is received are then the following: the side wall 38, the side wall 40, the front wall 34 and the partition 48.

This tracking device according to the second embodiment comprises a first foodstuff retrieval element comprising a second container 65a which can be weighed independently of the container 1 defining the cavity 2.

Furthermore, the weighing system 64 comprises a second scale 67a in addition to the scale 66. The second scale 67a is configured to acquire measurements indicative of the weight of the second container 65a and of foodstuffs retrieved by the second container 65a.

The second scale 67a and the second container 65a are arranged between the container 1 and one of the walls of the casing 32.

Preferably, the container 1 is arranged so that an upper rim of the container 1 overhangs the second container 65a. This has the advantage of limiting the risks of falling of foodstuffs between the container 1 and the second container 65a, thus escaping any weighing by the weighing system 64.

For example, in the embodiment represented in FIG. 10, the second scale 67a and the second container 65a are arranged between the container 1 and the side wall 38, and the upper rim of the container which overhangs the second container 65a is the upper side rim 20.

This tracking device according to the second embodiment also comprises a second foodstuff retrieval element comprising a third container 65b which can be weighed independently of the container 1 defining the cavity 2 and of the second container 65a.

Furthermore, the weighing system 64 comprises a third scale 67b. The third scale 67b is configured to acquire measurements indicative of the weight of the third container 65b and of foodstuffs retrieved by the second container 65b.

The third scale 67b and the third container 65b are arranged between the container 1 and one of the side walls of the casing 32, for example the side wall 40. In other words, the container 1 is arranged between the retrieval elements formed by the additional containers 65a and 65b.

Preferably, the container 1 is arranged so that an upper rim of the container 1 overhangs the second container 65b. This has the advantage of limiting the risks of falling of foodstuffs between the container 1 and the second container 65b, thus escaping any weighing by the weighing system 64.

For example, in the embodiment represented in FIG. 10, the third scale 67b and the third container 65b are arranged between the container 1 and the side wall 40, and the upper rim of the container which overhangs the third container 65b is the upper side rim 22.

The scales 67a, 67b are for example identical to the scale 66.

The weighing system 64 also comprises a processing unit configured to determine the weight of the foodstuffs that have been taken from the container but that have not been retrieved by each retrieval element during the period of time, from the measurements acquired by the first scale 66 and the measurements acquired by the second scale 67a and the third scale 67b. This processing unit is for example the electronic card 72.

In this second embodiment, the foodstuff retrieval elements formed by the upper rims 16, 18, 20, 22 of the container 1 represented in FIG. 1 are preserved, but could also be removed from the container 1.

The second container 65a can extend up to the side wall 38 of the casing. Furthermore, the third container 65b can extend up to the side wall 40 of the casing.

The device according to this second embodiment operates in the same way as the tracking device according to the first embodiment, within the following differences.

Each additional scale 67a, 67b applies the same steps as those implemented by the scale 66, in parallel with the latter.

It is thus stored in the memory 74 in addition to the initial measurement P and to the final measurement Q, for each additional container:
an initial measurement P(i) indicative of a weight of foodstuffs retrieved by the additional container of index i when the animal enters the chamber 60 (obtained according to the same modes as for the first average P1),
a final measurement Q(i) indicative of a weight of foodstuffs retrieved by the additional container of index i when the animal exits the chamber 60 (obtained according to the same modes as for the second average P2),

The processing unit (the electronic card 72) then calculates the following value ΔP:

$$Δ P = ( Q - P ) - {\sum }_{i = 1}^{K} ( Q ( i ) - P ( i ) )$$

where K is the number of additional containers and additional scales present in the device (K=2 in the example illustrated in FIG. 10).

The value ΔP is representative of a weight of foodstuffs that have been taken from the container 1 but that have not been retrieved by any of the retrieval elements of the tracking device according to the second embodiment, that is to say the weight of foodstuffs actually consumed by the animal during the feeding sequence.

Of course, the second embodiment may be subject to variants.

For example, it can be provided that K can be equal to 1, 2, 3 or 4. In the case K=4, the four additional containers are arranged between the container and, respectively, the four walls that define the chamber 60.

### 3) OTHER EMBODIMENTS

Other embodiments of a tracking device are possible.

The support 52 is optional in the first embodiment. In this case, the container 1 is directly laid on the scale 66. The scale 66 then weighs only the container 1 and its possible content.

In the case where no support 52 is present in the tracking device, the walls that define the chamber where the container 1 is received can be the following: the side wall 38, the side wall 40, the front wall 34 and the partition 48.

The partition wall 48 is also optional. The walls that define the chamber where the container 1 is received can then be the following: the side wall 38, the side wall 40, the front wall 34 and the rear wall 36.

Of course, when the support 52 and/or the partition 48 is/are removed, the width and/or the length of the container 1 can then be increased so that at least one of the retrieval elements extends from the cavity 2 up to one of the walls defining the chamber 60.

In addition, the different types of retrieval elements can be mixed in some embodiments (at least one additional container + at least one upper rim of the container, extending where appropriate up to one of the walls defining the chamber 60). Different configurations of the retrieval elements could be envisaged: one, preferably two, preferably three, preferably four rims and/or one, preferably two, preferably three, preferably four additional containers. Advantageously, at least one retrieval element extends up to each wall defining the chamber 60. Thus, the loss of foodstuffs out of the container is minimized and the device allows providing an individual consumption of an individual over a period given reliably and accurately.

In any one of the embodiments described, at least one flexible seal can connect an edge of the container 1 to one of the walls defining the chamber 60. For example, in the first embodiment, a first seal may be provided connecting the edge 28 to the side wall 38 and/or a second seal connecting the edge 30 to the wall 56 (or the side wall 40 in the case where there is no support 52).

It has been seen that, in the first embodiment, there is a substantial distance between the upper front rim 16 of the container and the front wall 34. As a variant, it can be provided that this upper front rim extends up to the front wall 34.

In this case, the length L2 of the container 1 measured between its two front and rear opposite free edges 24, 26 is substantially equal to the distance separating the front wall of the casing 34 and the second wall 58 of the support 52, so that the container 1 extends substantially from the front wall 34 up to the wall opposite thereto (second wall 58 for example or rear wall 36).

When the length L2 and the width L1 of the container 1 meet these conditions simultaneously, the four upper rims 24, 26, 28, 30 of the container 1 each extend substantially from the cavity of the container up to one of the walls defining the chamber 60 where the container 1 is received: the upper front rim 24 extends up to the front wall 34, the rear rim 26 extends up to the second wall 58, the side rim 28 extends up to the side wall 38 of the casing 32, and the other side rim 28 extends up to the first wall 56 of the support 52. In other words, the dimensions of the container 1 substantially coincide with the dimensions of the chamber 60.

1. A device comprising:
walls defining therebetween a chamber, the walls including a front wall defining a window to allow an animal to access the chamber from outside the tracking device, a rear wall, and two side walls;
a container arranged in the chamber and defining a cavity to store foodstuffs to be taken by the animal;
a foodstuff retriever to retrieve foodstuffs expelled out of the cavity and not consumed by the animal, wherein the foodstuff retriever extends from the cavity to at least one of the walls;
a weighing system configured to determine a weight of foodstuffs that have been taken from the cavity and that have not been retrieved by the foodstuff retriever during a period of time, the weighing system comprising a scale arranged in the chamber and configured to acquire measurements indicative of a cumulative weight of the container and of foodstuffs contained in the cavity.

2. The device according to claim 1, wherein the foodstuff retriever comprises a foodstuff retrieval element extending from the cavity up to one of the two side walls.

3. The device according to claim 1, wherein the foodstuff retriever comprises a first foodstuff retrieval element extending from the cavity up to a first of the walls, and a second foodstuff retrieval element extending from the cavity up to a second of the walls, wherein the container is arranged between the first wall and the second wall.

4. The device according to claim 3, wherein:
the container has a first edge and a second edge opposite to the first edge, and the container has a width measured between the first edge and the second edge which is substantially equal to a distance separating the first wall and the second wall, so that the container extends from the first wall up to the second wall,
the first foodstuff retrieval element forms a first upper rim of the container extending from the cavity up to the first edge,
the second foodstuff retrieval element forms a second upper rim of the container extending from the cavity up to the second edge.

5. The device according to claim 4, comprising flexible seals connecting the first edge and the second edge to the first and second walls, respectively.

6. The device according to claim 1, wherein the foodstuff retriever comprises a second container arranged to be weighed independently of the container, and wherein the weighing system further comprises:
a second scale configured to acquire measurements indicative of a weight of the second container and of foodstuffs retrieved by the second container,
a processing unit configured to determine a weight of foodstuffs that have been taken from the container and that have not been retrieved by the foodstuff retriever during the period of time, from the measurements acquired by the first scale and the second scale.

7. The device according to claim 6, wherein the container comprises an upper rim extending from the cavity towards one of the walls so as to overhang the second container.

8. The device according to claim 6 wherein the foodstuff retriever comprises a third container arranged to be weighed independently of the container and independently of the second container, and wherein
the weighing system comprises a third scale configured to acquire at least one measurement indicative of a weight of the third container and of foodstuffs retrieved by the third container,
the processing unit is configured to determine a weight of foodstuffs that have been taken from the container and that have not been retrieved by the foodstuff retriever during the period of time, from the measurements acquired by the first scale, the second scale and the third scale.

9. The device according to claim 8, wherein the container comprises a first upper rim extending from the cavity towards one of the walls so as to overhang the second container, and a second upper rim extending from the cavity towards another of the walls of so as to overhang the third container, the cavity being arranged between the first upper rim and the second upper rims.

10. The device according to claim 1, wherein the weighing system comprises an infinite impulse response filter configured to eliminate or not a measurement acquired by the scale depending on a weight measurement previously acquired by the scale.

11. The device according to claim 1, wherein the scale is an electronic scale less accurate than a scale having an accuracy of 0.01 grams.

12. The device according to claim 1, wherein the window has a maximum diameter less than or equal to 19 centimeters.

13. The device according to claim 1, wherein the window has a lower edge elevated relative to the container.

14. The device according to claim 1, comprising a rim extending between the window and the container so as to partially overhang the container.

15. The device according to claim 1, wherein the window has an adjustable size.

16. The device according to claim 1, wherein the window is arranged to be at least 7 centimeters from a floor on which the device is laid.

17. The device according to claim 1, comprising a roof having a convex or inclined shape to prevent an animal from standing on the roof when the device is laid on a floor.

18. The device according to claim 1, wherein the front wall is at least partly transparent.

19. The device according to claim 1, comprising a detector configured to detect an entry of an animal into the chamber via the window and an exit of the animal out of the chamber via the window, and wherein the system weighing (64) is configured so that the period of time begins when the detector detects the entry of the animal and ends when the detector detects the exit of the animal.

20. The device according to claim 19, wherein the detector comprises an infrared beam emitter, and a receiver arranged to receive a infrared beam emitted by the infrared beam emitter, the infrared beam emitter being arranged so that the infrared beam is interrupted by an animal accessing the chamber via the window.

21. The device according to claim 1, further comprising a radio-identification reader adapted to receive data from a radio-label carried by an animal accessing the chamber via the window, wherein the data allows the animal to be identified in a database of individuals.

22. The device according to claim 14, wherein the rim is inclined towards the container so that a foodstuff falling on the rim then falls back into the container.
